(19) United States
(12) Patent Application Publication
(10) Pub. No.: US 2014/0284073 A1
(43) Pub. Date: Sep. 25, 2014

(54) CABLE INCLUDING REINFORCEMENT ELEMENTS

(71) Applicant: LS Cable & System Ltd., Anyang-si (KR)

(72) Inventors: Hyun-Woong KIM, Seoul (KR); Chan-Yong Park, Gunpo-si (KR); Soo-Jung Yang, Uiwang-si (KR)

(73) Assignee: LS Cable & System Ltd., Anyang-si (KR)

(21) Appl. No.: 14/220,219

(22) Filed: Mar. 20, 2014

(30) Foreign Application Priority Data
Mar. 20, 2013 (KR) 10-2013-0029573

(51) Int. Cl. H01B 7/18

(52) U.S. Cl. CPC H01B 7/186
USPC 174/102 SC; 174/115

(57) ABSTRACT

The present invention relates to a cable including reinforcement elements. The cable according to the present invention includes at least one power conductors, at least one ground conductors, a semi-conducting layer configure to surround at least part of the power conductors and the ground conductors, and at least one ground check conductor insulated from the ground conductors and configured to check the ground state of the ground conductors. The ground check conductor includes a plurality of conductors, at least one reinforcement elements provided along the outer circumference of the conductors, and an insulator configured to surround the conductors and the reinforcement elements.

### CROSS REFERENCE TO RELATED APPLICATION

This application claims the benefit of the Patent Korean Application No. 10-2013-0029573, filed on Mar. 20, 2013, which is hereby incorporated by reference as if fully set forth herein.

### BACKGROUND OF THE DISCLOSURE

1. Field of the Disclosure

The present invention relates to a cable including reinforcement elements and, more particularly, to a cable including reinforcement elements for reinforcing strength in order to prevent damage to a frequently moved cable.

2. Discussion of the Related Art

Recently, there is an effort to reduce the generation of carbon dioxide as part of a worldwide agreement or environment protection, and thus there is a growing tendency toward replacing an internal combustion engine with an electrical transmission gear as part of the effort. Accordingly, there is an increasing demand for a cable for supplying power to an electrical transmission gear, and a need for the movable characteristic of a cable is increasing in terms of characteristics in using the cable. That is, not only common electrical characteristics necessary for a cable, but the mechanical performance of the cable according to a frequent movement must be guaranteed. Accordingly, there is an increasing demand for the mechanical reinforcement of a conductor for guaranteeing the electrical characteristics.

Mechanical damage according to the movable characteristic of a cable can be divided into a case where the outside of the cable is damaged and a case where the inside of the cable is damaged. The case where the outside of the cable is damaged can include abrasion, damage due to a shock, and environment damage. The degree of this damage is chiefly determined by the polymer characteristic of a sheath that surrounds the outer circumference of the cable. Furthermore, the case where the inside of the cable is damaged can include torsion damage, bending damage, and tension damage. The degree of this damage is chiefly determined by the conductor and structure of the cable.

As a result, an electrical role of a cable requires a basic function for smoothly supplying power and signals and a function of blocking the above-described cable damage electrically and rapidly. For example, a mining cable used in a mine includes a power conductor, an ground conductor, and a ground check conductor for the functions. In this case, the sizes of the power conductor, the ground conductor, and the ground check conductor are determined in this order. Accordingly, in a cable subject to a lot of mechanical stress, a conductor of the ground check conductor may have the greatest risk of damage. In order to avoid damage to a cable, a cable structure is regulated in each country. The degree of weakness of a cable can vary depending on the regulations.

In order to prevent the above-described damage, U.S. Patent Laid-Open No. 2012-0111603A1 (hereinafter referred to as ‘Prior Document 1’) discloses a ground check conductor including aramid yarn within a conductor. However, the construction of Prior Document 1 is problematic in that a process of manufacturing a conductor is complicated because a reinforcement unit is included in the conductor and aramid yarn is damaged by the pressure of the conductor when stress acts on the conductor. Furthermore, a structure including a reinforcement unit in a conductor may not comply with various cable standards regulated in countries.

German Patent No. 3064311 (hereinafter referred to as ‘Prior Document 2’) discloses technology in which a reinforcement unit is provided at the central part of each of the conductors of a multi-core cable that is used for mobile use. Prior Document 2 has similar problems to Prior Document 1.

Furthermore, WO/2011/033539 (hereinafter referred to as ‘Prior Document 3’) discloses a cable including an asymmetrical reinforcement element. If a reinforcement element is asymmetrically disposed as in Prior Document 3 because a common cable has a symmetrical structure, however, the center of gravity of the cable is inclined to one side, with the result that abrasion can become severe only on one side when the cable is moved.

### SUMMARY OF THE DISCLOSURE

Accordingly, the present invention has been made in view of the above problems, and it is an object of the present invention to provide a cable which complies with standards regulated in countries in order to avoid damage to the cable and which can prevent damage to the cable. In particular, an object of the present invention is to provide a cable capable of preventing damage to the conductors of lines within the cable that needs to be frequently moved and of facilitating the manufacturing of the lines.

In order to achieve the objects, a cable including reinforcement elements, comprises at least one power conductor, at least one ground conductors, a semi-conducting layer configure to surround at least part of the power conductors and the ground conductors and at least one ground check conductor insulated from the ground conductors and configured to check an ground state of the ground conductors, wherein the ground check conductor comprises a plurality of conductors, at least one reinforcement elements provided along an outer circumference of the conductors, and an insulator configured to surround the conductors and the reinforcement elements.

Here, the plurality of conductors is wound at a specific pitch, and the reinforcement elements have a pitch greater than the pitch of the conductors and surround the conductors.

Furthermore, a pitch angle of the reinforcement element is smaller than a pitch angle of the conductor.

The reinforcement element is made of at least one of aramid fiber, polyamide fiber, polyester fiber, and a mixture of the aramid fiber, the polyamide fiber, and the polyester fiber.

The reinforcement element is made of fiber selected from fibers having strength of 1.1 Gpa or more.

The cable further comprises an insulating film configured to surround an outer circumference of the reinforcement elements.

In order to achieve the objects, a cable including reinforcement elements, comprises at least one power conductor, at least one ground conductors and at least one ground check conductor configured to check an ground state of the ground conductors, wherein the ground check conductor comprises a plurality of conductors, reinforcement elements provided along an outer circumference of the conductors, and an insulator configured to surround the conductors and the reinforcement elements, the plurality of conductors is wound at a specific pitch, and the reinforcement elements have a pitch greater than the pitch of the conductors and surround the conductors.

A pitch angle of the reinforcement element is smaller than a pitch angle of the conductor.

The reinforcement element is made of at least one of aramid fiber, polyamide fiber, polyester fiber, and a mixture of the aramid fiber, the polyamide fiber, and the polyester fiber.

The reinforcement element is made of fiber selected from fibers having strength of 1.1 Gpa or more.

The cable further comprises an insulating film configured to surround an outer circumference of the reinforcement elements.

The cable further comprises an insulator configured to surround the power conductors, the ground conductors, and the ground check conductor.

### BRIEF DESCRIPTION OF THE DRAWINGS

FIG. 1 is a cross-sectional view showing the internal construction of a cable in accordance with an embodiment of the present invention;

FIG. 2 is a cross-sectional view showing the internal construction of a cable in accordance with another embodiment of the present invention;

FIG. 3 is a cross-sectional view of a cable including reinforcement elements according to the present invention;

FIG. 4 is a cross-sectional view of a ground check conductor of FIG. 3 in accordance with an embodiment of the present invention;

FIG. 5 is a schematic diagram showing a comparison between the pitches of the conductor and the reinforcement element of the cable of FIG. 4;

FIG. 6 is a cross-sectional view of the ground check conductor of FIG. 3 according to another embodiment; and

FIG. 7 is a perspective view showing the construction of the ground check conductor of FIG. 6.

### DESCRIPTION OF SPECIFIC EMBODIMENTS

Optical fiber cables in accordance with various embodiments of the present invention are described in detail with reference to the accompanying drawings.

In general, a cable is connected to a device fixed at a certain place or a moving device and configured to transfer a power or electrical signal. In particular, there is recently an effort to reduce the generation of carbon dioxide as part of a worldwide agreement or environment protection, and thus there is a growing tendency toward replacing an internal combustion engine with an electrical transmission gear as part of the effort. Accordingly, there is an increasing demand for a cable for supplying power to an electrical transmission gear, and a need for the movable characteristic of a cable is increasing in terms of characteristics in using the cable. That is, not only common electrical characteristics necessary for a cable, but the mechanical performance of the cable according to a frequent movement must be guaranteed. Accordingly, there is an increasing demand for the mechanical reinforcement of a conductor for guaranteeing the electrical characteristics.

As a result, an electrical role of a cable requires a basic function for smoothly supplying power and signals and a function of blocking the above-described cable damage electrically and rapidly. A mining cable that needs to be frequently moved and that requires a high level of mechanical strength is described below as an example.

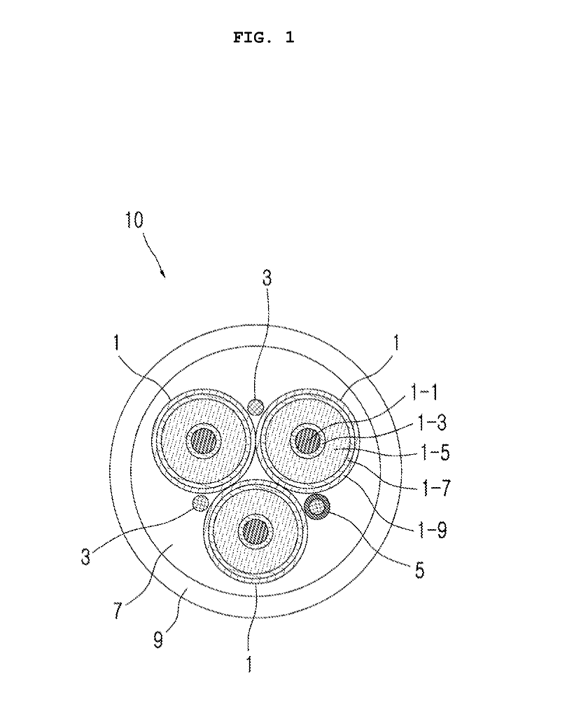

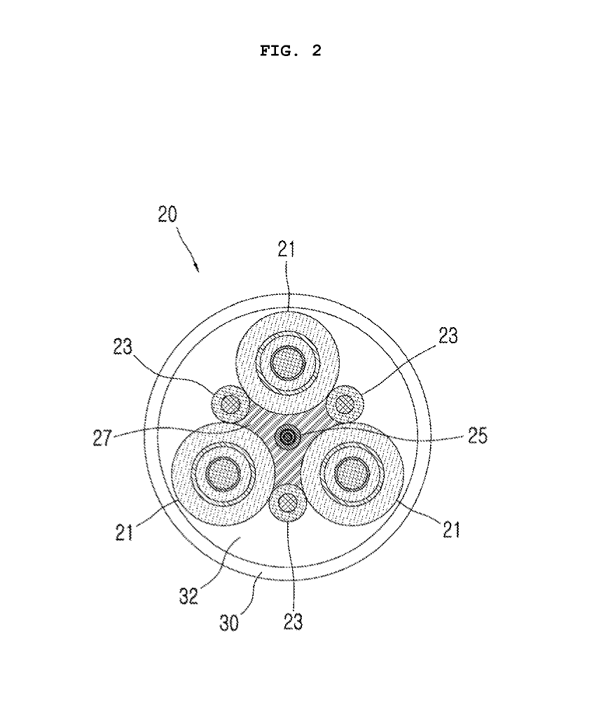

FIGS. 1 and 2 show the constructions of mining cables 10 and 20 used in a mine. FIG. 1 shows a mining cable in accordance with an ‘Insulated Cable Engineer's Association (ICEA)’ standard, and FIG. 2 shows a mining cable in accordance with an AS/NZS standard.

Referring to FIG. 1, the mining cable 10 in accordance with an embodiment of the present invention includes a power conductor 1, a ground conductor 3, and a ground check conductor 5. The number of power conductors 1 is one or more. The power conductor 1 includes a conductor 1-1, an internal semi-conducting layer 1-3, an insulating layer 1-5, an external semi-conducting layer 1-7, and a sheath 1-9 from the inside of the power conductor 1.

The mining cable 10 can be a three-phase cable including, for example, three power conductors 1 as shown in FIG. 1. In this case, the mining cable 10 can include at least one ground conductor 3 for grounding the power conductors 1 and the ground check conductor 5 for checking the state of the ground conductors 3. A proper number of the ground conductors 3 can be provided in order to ground the power conductors 1. For example, two ground conductors 3 can be provided as shown in FIG. 1.

Meanwhile, the mining cable 10 can include the ground check conductor 5 for checking the ground state of the ground conductors 3. The number of ground check conductors can be, for example, one or more as shown in FIG. 1. Although not shown, the ground check conductor 5 is connected with the ground conductors 3 and configured to check the ground state of the ground conductors 3. Accordingly, if the ground conductor 3 of the mining cable is damaged, the damage to the mining cable 10 can be restoredrapidly because the damage can be checked through the ground check conductor 5 rapidly. The power conductors 1, the ground conductors 3, and the ground check conductor are surrounded by an insulating layer 7, and a sheath layer 9 for protecting the cable is provided on the outermost side of the mining cable.

Meanwhile, FIG. 2 shows a mining cable 20 according to another embodiment of the present invention.

Referring to FIG. 2, the mining cable 20 is similar to the mining cable of the previous embodiment in that it includes power conductors 21, ground conductors 23, a ground check conductor 25, and a sheath layer 30 provided on the outermost side of the mining cable, but has a different internal construction from the mining cable of the above-described embodiment. The functions of the power conductor 21, the ground conductor 23, and the ground check conductor 25 have been described above, and thus a repetitive description thereof is omitted. Differences between the mining cable 20 of the present embodiment and the mining cable of the previous embodiment are chiefly described.

In the internal construction of the mining cable 20, the power conductors 21, the ground conductors 23, and the ground check conductor 25 form a symmetrical structure. That is, the mining cable 20 includes the three power conductors 21, and the ground conductor 23 is provided between the power conductors 21. Furthermore, the ground check conductor 25 is provided at the central part of the mining cable 20. Accordingly, the ground check conductor 25 is placed at the very center of the mining cable 20, and the power conductors 21 and the ground conductors 23 are disposed along the outer circumference of the ground check conductor 25.

In this case, the ground check conductor 25 is electrically separated from the power conductors 21 and the ground conductors 23 by way of a separation element 27 made of synthetic resin. The ground check conductor 25 functions to check the ground state of the ground conductors 23. Thus, the ground check conductor 25 is connected with the ground conductors 23 at the end of the mining cable 20, but is insulated from the ground conductors 23 in the remaining parts of the mining cable 20 by way of the separation element 27. Meanwhile, the mining cable 20 according to the present embodiment further includes a semi-conducting layer 32 that surrounds at least portion of the power conductors 21 and the ground conductors 23.

FIGS. 1 and 2 illustrate a mining cable in accordance with the ICEA standard being widely used in U.S.A. and Europe and a mining cable in accordance with the AS/NZS standard being widely used in Australia. As described above, the power conductors, the ground conductors, and the ground check conductor of FIGS. 1 and 2 have similar basic constructions, but they have a slight difference in their arrangement. Meanwhile, in a mining cable, the size of each of a power conductor, a ground conductor, and a ground check conductor is determined by desired performance, but the sizes are commonly determined in the sequence of the power conductor, the ground conductor, and the ground check conductor. Accordingly, in a cable subject to the mechanical stress, a conductor of a ground check conductor having the smallest diameter (or size) may have the greatest risk of damage.

When tensile force is applied to a cable having a specific construction, the greatest tension stress acts on the central part of the cable, in most cases. Accordingly, in the case of a mining cable, such as that of FIG. 2, the greatest tension stress acts on the ground check conductor 25 located at the central part of the mining cable. As a result, in the case of the mining cable of FIG. 2 in accordance with the AS/NZS standard, the ground check conductor 25 has the smallest size, and the greatest tension stress acts on the ground check conductor 25 placed at the central part of the mining cable. Thus, the mining cable requires a construction for preventing damage to the ground check conductor 25. In the case of the mining cable of FIG. 1 in accordance with the ICEA standard, the ground check conductor 5 is placed relatively at the central part of the mining cable, and the ground check conductor 5 has a diameter relatively smaller than another conductor. Accordingly, the mining cable of FIG. 1 also requires a construction for preventing damage to the ground check conductor 5.

As a result, when tensile force, bending force, etc. are applied to a mining cable, a conductor of a ground check conductor may have a high possibility that damage can occur in the internal construction of the mining cable. Accordingly, the mining cable requires a construction for preventing damage to the ground check conductor. Hereinafter, a cable including a reinforcement element for preventing damage to a ground check conductor as described above is described in detail.

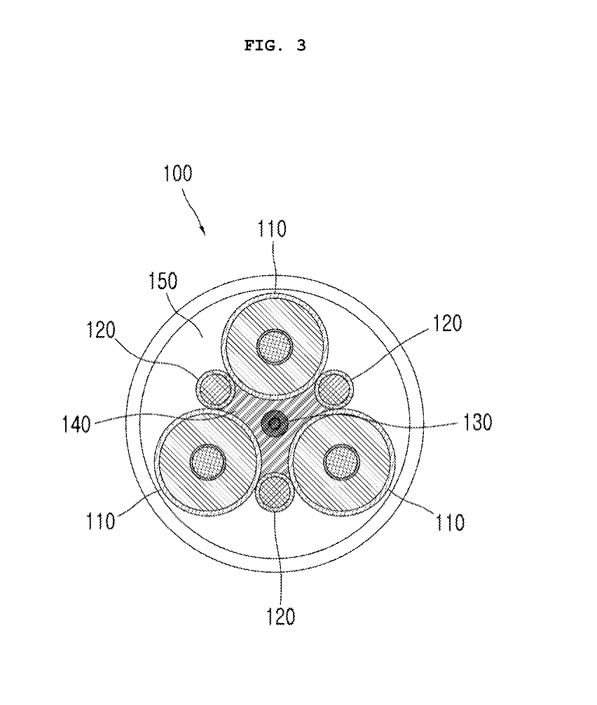

FIG. 3 is a cross-sectional view showing the internal construction of a mining cable 100 according to another embodiment of the present invention. A mining cable in accordance with the AS/NZS standard is described below as an example, but the present invention is not limited thereto. The present invention can also be applied to a mining cable in accordance with the ICEA standard.

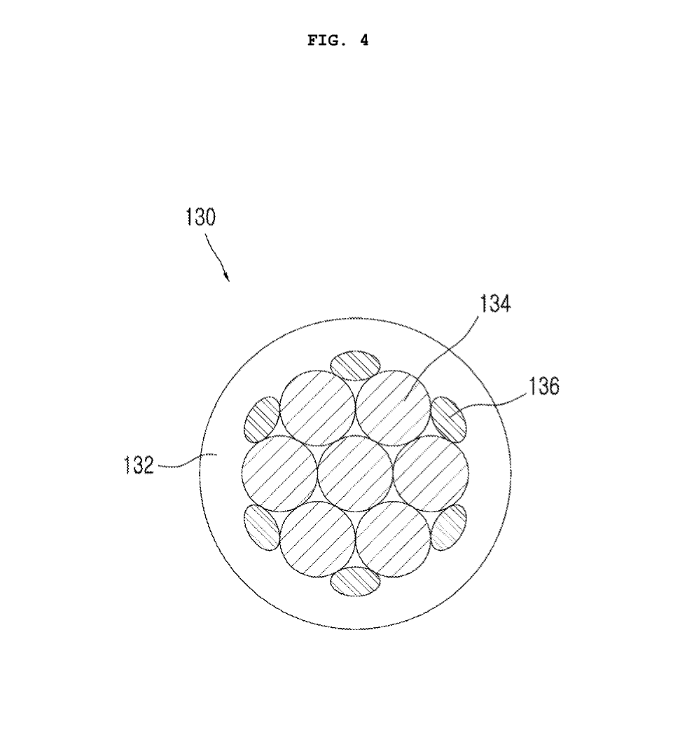

Referring to FIG. 3, the mining cable 100 includes at least one power conductor 110, at least one ground conductor 120, and at least one ground check conductor 130 insulated from the ground conductors 120 and configured to check the ground state of the ground conductors 120. The mining cable 100 further includes a semi-conducting layer 150 for surrounding the power conductors 110 and the ground conductors 120. The ground check conductor 130 includes conductors (refer to 134 of FIG. 4), reinforcement elements (refer to 136 of FIG. 4) provided along the outer circumference of the conductors 134, and an insulator (refer to 132 of FIG. 4) configured to surround the conductors 134 and the reinforcement elements 136. Here, the power conductors 110, the ground conductors 120, the ground check conductor 130, the separation element 140 insulating the ground check conductor 130 from the ground conductors 120, and the semi-conducting layer 150 surrounding the power conductors 110 and the ground conductors 120 have been described in connection with the above-described embodiments, and a repetitive description thereof is omitted.

The mining cable 100 includes the ground check conductor 130 including the reinforcement elements 136. In particular, the mining cable 100 includes the reinforcement elements 136 provided along the outer circumference of the conductors 134 of the ground check conductor 130. As described above, in the conventional cable, the reinforcement element is provided at the central part of the conductors in order to enhance the mechanical characteristics of the ground check conductor because the central part of the mining cable has the weakest tensile force. In general, when a cable is installed, a wire is manufactured by winding the wire so that it has a specific pitch in order to increase flexibility. This structure is extended through the specific pitch when tensile force acts on the structure. That is, reinforcement elements do not need to be disposed at the central part of the cable though the greatest tension stress acts on the central part of the cable. For example, if reinforcement elements each having a greater pitch than each of conductors are provided along the outer circumference of the conductors, the reinforcement elements can sufficiently prevent damage to the conductors before the conductors are extended by tensile force applied to the cable. To this end, the mining cable 100 includes the ground check conductor 130 provided with the reinforcement elements 136. Furthermore, the reinforcement elements 136 are configured to have a pitch greater than the pitch of the conductors 134 along the outer circumference of the conductors 134 of the ground check conductor 130.

FIG. 4 is a cross-sectional view of the ground check conductor 130 of the mining cable 100.

Referring to FIG. 4, the ground check conductor 130 may include a plurality of the conductors 134 provided approximately at the center of the mining cable 100 and the one or more reinforcement elements 136 provided along the outer circumference of the conductors 134 in such a way as to surround the conductors 134.

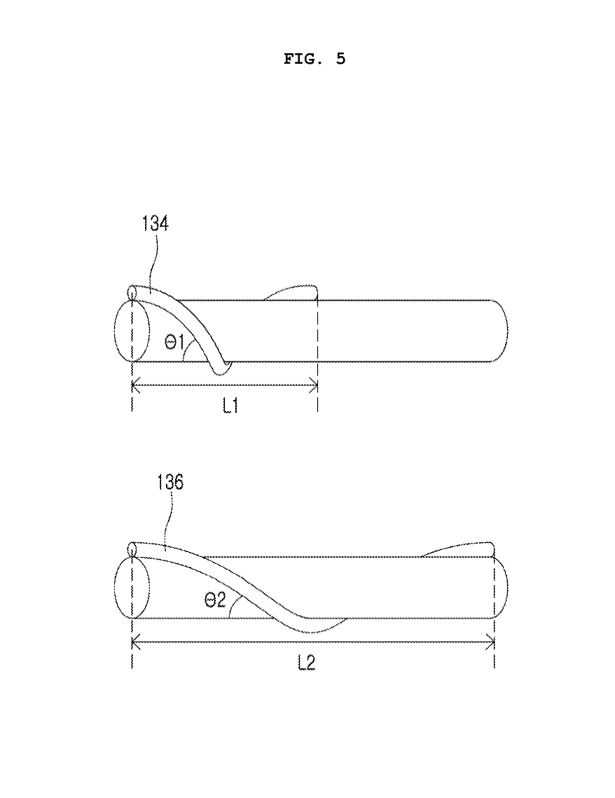

A plurality of the conductors 134 gathers to form one set, and the conductors 134 are wound to have a specific pitch (refer to L1 of FIG. 5).

The one or more reinforcement elements 136 surround the outer circumference of the conductors 134. For example, the number of reinforcement elements 136 may be about 2 to 6. Here, the reinforcement element 136 may be made of at least one of aramid fiber, polyamide fiber, polyester fiber, and a mixture of the fibers, and may be made of, for example, aramid yarn. Furthermore, the reinforcement element 136 may be made of fiber selected from fibers having strength of 1.1 Gpa or more. The fibers have been widely known in the art, and a detailed description thereof is omitted.

The reinforcement elements 136 are configured to have a pitch (refer to L2 of FIG. 5) greater than the pitch L1 of the conductors 134. FIG. 5 is a schematic diagram showing a comparison between the pitch of the conductors 134 and the pitch of the reinforcement elements 136.

Referring to FIG. 5, when comparing one pitch L1 of the conductor 134 with one pitch L2 of the reinforcement element 136, the pitch L2 of the reinforcement element 136 is greater than the pitch L1 of the conductor 134. Furthermore, this may mean that a pitch angle θ2 of the reinforcement element 136 is smaller than a pitch angle θ1 of the conductor 134. That is, if the reinforcement element 136 is wound while forming the specific pitch L2, the pitch angle θ2 from a horizontal line can be smaller than the pitch angle θ1 of the conductor 134.

As a result, the reinforcement element 136 is provided on the outer circumference of the conductor 134. As described above, although the reinforcement element 136 is provided on the outer circumference of the conductor 134, resistance against to the tensile force of the conductor 134 can be sufficiently increased. Furthermore, when manufacturing the conductors 134, it is advantageous to provide the reinforcement elements 136 along the outer circumference of the conductors 134 rather than the inside of the conductors 134. In particular, the reinforcement element 136 has the pitch L2 greater than the pitch L1 of the conductor 134. Accordingly, the reinforcement elements 136 are first deformed before the conductors 134 are deformed by tensile force, with the result that the reinforcement elements 136 absorb the tensile force and thus prevent damage to the conductors 134.

Table 1 below is a table a comparison of tensile strength in the mining cable in accordance with an embodiment of the present invention and a conventional mining cable.

TABLE 1

| | Embodiment | Comparison Example |
|---|---|---|
| Maximum tensile | 380 | 320 |
| strength (N) | | |

In Table 1, ‘Embodiment’ refers to the mining cable including the ground check conductor shown in FIG. 4, and ‘Comparison Example’ refers to the mining cable of FIG. 2 in which the reinforcement elements are included on the inside of the conductors of the ground check conductor.

From Table 1, it can be seen that ‘Embodiment’ has better tensile strength than ‘Comparison Example’. That is, in ‘Embodiment’, maximum tensile strength is about 380N. In contrast, in ‘Comparison Example’, maximum tensile strength is about 320N. That is, it can be seen that the maximum tensile strength of ‘Embodiment’ is about 18% or higher than the maximum tensile strength of ‘Comparison Example’. Therefore, it can be seen that if the reinforcement elements each having a pitch greater than the pitch of the conductor is provided along the outer circumference of the conductors, tensile strength better than that of a case where the reinforcement elements are provided on the inside of the conductors can be provided.

Meanwhile, in the productivity of the mining cables according to ‘Embodiment’ and ‘Comparison Example’, ‘Embodiment’ has very excellent productivity, whereas ‘Comparison Example’ has relatively very low productivity. This is because if the reinforcement elements are provided on the inside of the conductors of the ground check conductor as in ‘Comparison Example’, lots of processes are necessary when manufacturing the conductors, thereby making difficult to manufacture the mining cable, as described above.

Furthermore, in the diameters of the mining cables according to ‘Embodiment’ and ‘Comparison Example’, it can be seen that the diameter of the mining cable according to ‘Embodiment’ is relatively smaller than the diameter of the mining cable according to ‘Comparison Example’. In ‘Embodiment’, the reinforcement elements are provided along the outer circumference of the conductors of the ground check conductor. In this case, as shown in FIG. 4, at least part of the reinforcement element 136 is inserted into the space between neighboring conductors 134. Accordingly, in terms of the total diameter of the ground check conductor 130, there is no significant difference from a case where the reinforcement elements are not included. In contrast, in ‘Comparison Example’, it can be seen that the diameter of the conductor is increased because additional reinforcement elements are provided on the inside of the conductors and thus the total diameter of the ground check conductor is increased. If the diameter of the ground check conductor is increased as described above, the total volume and disposition of the mining cable including the ground check conductor are changed. As a result, the disposition and manufacturing of the mining cable may become difficult.

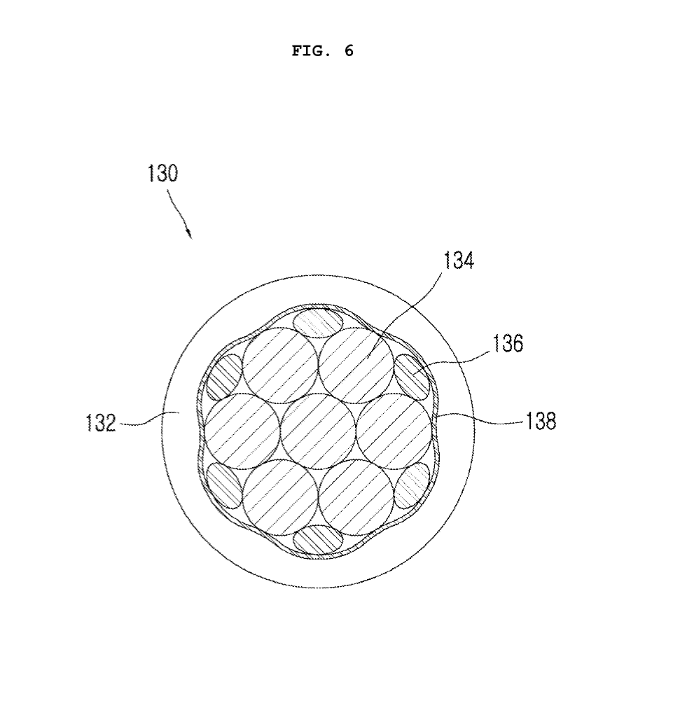

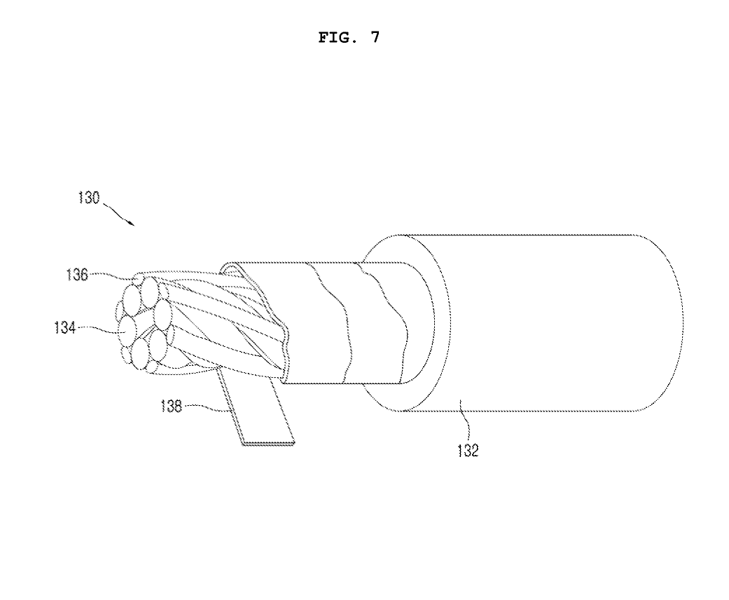

FIGS. 6 and 7 show the ground check conductor 130 of the mining cable 100 according to another embodiment of the present invention.

Referring to FIGS. 6 and 7, the ground check conductor 130 includes the conductors 134, the reinforcement elements 136 surrounding the outer circumference of the conductors 134, and an insulating film 138 surrounding the outer circumference of the reinforcement elements 136. That is, a plurality of the conductors 134 is wound at a specific pitch L1 so that they form one set, and the reinforcement elements 136 having the pitch L2 greater than the pitch L1 of the conductors 134 are provided along the outer circumference of the conductors 134. Furthermore, the insulating film 138 is provided along the outer circumference of the reinforcement elements 136. The insulating film 138 functions to primarily insulate the reinforcement elements 136 and the conductors 134 from the outside and also functions to surround the reinforcement elements 136 and the conductors 134 so that they form one aggregate. The insulator 132 is provided on the outermost side of the ground check conductor 130.

Meanwhile, in the case of the mining cable including the reinforcement elements 136, the mining cable 100 in accordance with the AS/NZS standard has been described as an example, but this is only an example. That is, the constructions of the ground check conductors included in the mining cables of FIGS. 3 to 7 can also be applied to a mining cable in accordance with another standard, for example, a mining cable in accordance with the ICEA standard. In this case, the mining cable includes at least one power conductor, at least one ground conductor, and at least one ground check conductor for checking the ground state of the ground conductors. Here, the ground check conductor can be configured to include conductors, reinforcement elements provided along the outer circumference of the conductors, and an insulator configured to surround the conductors and the reinforcement elements. Furthermore, the mining cable can include power conductors, ground conductors, and an insulator configured to surround a ground check conductor. The construction of the ground check conductor is similar to that of the above-described embodiment, and thus a repetitive description thereof is omitted.

The cable having the above constructions according to the present invention complies with standards regulated in countries in order to avoid damage to the cable and can also prevent damage to the cable.

In particular, in a mining cable that needs to be frequently moved, damage to the conductors of lines within the mining cable can be prevented, and the lines can be easily manufactured.

Although the exemplary embodiments of the present invention have been described above, those skilled in the art will appreciate that the present invention can be modified and changed in various ways without departing from the spirit and scope of the present invention which are written in the claims below. Accordingly, any modified implementation can be considered to be included in the technical category of the present invention as long as the modified implementation basically falls within the claims of the present invention.

What is claimed is:

1. A cable including reinforcement elements, comprising:
at least one power conductor;
at least one ground conductors;
a semi-conducting layer configure to surround at least part of the power conductors and the ground conductors; and
at least one ground check conductor insulated from the ground conductors and configured to check an ground state of the ground conductors,
wherein the ground check conductor comprises a plurality of conductors, at least one reinforcement elements provided along an outer circumference of the conductors, and an insulator configured to surround the conductors and the reinforcement elements.

2. The cable of claim 1, wherein:
the plurality of conductors is wound at a specific pitch, and
the reinforcement elements have a pitch greater than the pitch of the conductors and surround the conductors.

3. The cable of claim 1, wherein a pitch angle of the reinforcement element is smaller than a pitch angle of the conductor.

4. The cable of claim 1, wherein the reinforcement element is made of at least one of aramid fiber, polyamide fiber, polyester fiber, and a mixture of the aramid fiber, the polyamide fiber, and the polyester fiber.

5. The cable of claim 1, wherein the reinforcement element is made of fiber selected from fibers having strength of 1.1 Gpa or more.

6. The cable of claim 1, further comprising an insulating film configured to surround an outer circumference of the reinforcement elements.

7. A cable including reinforcement elements, comprising:
at least one power conductor;
at least one ground conductors; and
at least one ground check conductor configured to check an ground state of the ground conductors,
wherein the ground check conductor comprises a plurality of conductors, reinforcement elements provided along an outer circumference of the conductors, and an insulator configured to surround the conductors and the reinforcement elements,
the plurality of conductors is wound at a specific pitch, and
the reinforcement elements have a pitch greater than the pitch of the conductors and surround the conductors.

8. The cable of claim 7, wherein a pitch angle of the reinforcement element is smaller than a pitch angle of the conductor.

9. The cable of claim 7, wherein the reinforcement element is made of at least one of aramid fiber, polyamide fiber, polyester fiber, and a mixture of the aramid fiber, the polyamide fiber, and the polyester fiber.

10. The cable of claim 7, wherein the reinforcement element is made of fiber selected from fibers having strength of 1.1 Gpa or more.

11. The cable of claim 7, further comprising an insulating film configured to surround an outer circumference of the reinforcement elements.

12. The cable of claim 7, further comprising an insulator configured to surround the power conductors, the ground conductors, and the ground check conductor.
